(19) United States
(12) Patent Application Publication
(10) Pub. No.: US 2008/0202296 A1
(43) Pub. Date: Aug. 28, 2008

(54) Tool for Machining Tire Profiles

(75) Inventor: Alfred Heimann, Korshenbroich (DE)

Correspondence Address: HARNESS, DICKEY & PIERCE, P.L.C., P.O. BOX 828, BLOOMFIELD HILLS, MI, 48303, US

(73) Assignee: HEGENSCHEIDT-MFD GMBH & CO. KG, Erkelenz (DE)

(21) Appl. No.: 11/662,430

(22) PCT Filed: Aug. 25, 2005
(86) PCT No.: PCT/EP2005/009186

§ 371 Date: Mar. 3, 2008

(30) Foreign Application Priority Data
Sep. 10, 2004 (DE) 10 2004 044 372.6

(51) Int. Cl. B23B 5/28

(52) U.S. Cl. 82/104; 407/66

(57) ABSTRACT

This tool is for processing wheel tire profiles for wheels (5) on a railway vehicle wheelset on a wheelset lathe that has a cylindrical or mushroom-shaped cutting tool (22) made from a hard material, such as carbide or cutting ceramics, that is fixed to a tool holder (23) which is positioned in a tool support that can be moved into the x and z axes of the wheelset lathe. The tool holder (23) is aligned below an acute angle (α) of a tangent (33) to the circle of a cut and at a level (4) perpendicular to the wheel tire profile. It is also able to be turned and moved along its longitudinal axis (31).

### CROSS-REFERENCE TO RELATED APPLICATION

This application is a National Stage of International Application No. PCT/EP2005/009186, filed Aug. 25, 2005, which claims priority to German Application No. DE 10 2004 044 372.6, filed Sep. 10, 2004. The disclosures of the above applications are incorporated herein by reference.

### FIELD

This tool is for processing wheel tire profiles for wheels on a railway vehicle wheelset on a wheelset lathe that has a cylindrical or mushroom-shaped cutting tool made from a hard material, such as carbide or cutting ceramics, that is fixed to a tool holder which is positioned in a tool support that can be moved into the x and z axes of the wheelset lathe.

### BACKGROUND AND SUMMARY

Long chips can arise during machining if special measures are not taken for the tools while working with steel. Removing these chips can be time-consuming and difficult. This is why tool manufacturers install swarf deflectors and humps on cutting tools of rotary tools. They are supposed to compress chips until they can no longer be worked and break off. The manufacturer generally informs the user in which infeed and cutting depth range the swarf guides occur. In this respect, a rotational cutting tool has become known from DE 23 39 588, which has two diagonally opposed angles as chip surfaces for the same working range and two angles positioned next to one another as chip surfaces with a complementary working range on each of the two faces used for chipping.

Another solution is to form and direct the chip in such a way that it collides with an object such as a work piece or tool. It must collide in such a manner that causes the chip to break off at the root. This produces small spiral swarfs.

A chamfer is used on a cutting tool to keep the cutting edge from breaking when making hard cuts. If such a plate is used when there is a small chip cross section, the chips will not break off since they no longer make contact with the chip-forming element. Therefore, a cutting tool can only cause the chips to break off when used in a specified working range.

Using different cutting tools during manufacturing can be very helpful.

When reprofiling wheels on wheelsets for railway vehicles, try to set the profile in such a way that it touches the wear profile at one point of the flank or on the running surface. Since you might want to remain in one cut for reasons due to accuracy and time, inducing swarf breaking may not be possible in every working range; especially when the cutting depth is low. This may heavily impair the working operation's automation and require additional devices for creating and removing chips.

For example, there is a known procedure from the EP 0 346 505 for creating chips while processing workpieces with a lathe, especially wheels on wheelsets for railway vehicles. The rotary tool's feed rate level changes for short periods of time when the wheelset is turned. Within a brief period of time, the cutting tool tip along the wheel tire profile is moved back each time to the feed line in circumference direction and brought back to the previous feed rate amount used for subsequent processing.

The known procedure causes a greater coarseness in a specific area. Short chips cannot be created at will since the support speeds are limited.

From DE-PS 558 905, a tool with an automatic rotating, overhung, circular cutting body has become known. The cutting tool works with greater exactness, because the detached chip is directed through the interior of the mushroom-shaped, hollow and rotating cutting body. The problem concerning the inducing of swarf is not addressed.

From DE 29 37 513 A1, the use of a cutting tool that rotates at a higher speed has become known. Here, a film of oil or lubricating fluid is developed in the cutting zone and in the tool-chip interface. The combination of lower friction and reduced shear forces makes it possible to create lamelliform chips of almost every dimension. However, this says nothing about how inducing swarf at different cutting depths can be effected in one single chipping cut.

The DE 33 05 700 C2 aims to create a higher surface quality of surface finish, as performed in the machine finish cutting of calendar paper rollers, in the processing of metals and their alloys as well as of non-metallic individual components on lathes. The known procedure has many similarities with rotational milling and describes the relative settings of tool and workpiece and their rotary motions relative to one another. Here, breaking the detached chips is also not spoken of.

The tool U.S. Pat. No. 5,014,581 known from the US, is designed to be used on lathes to process high-alloyed metals that are difficult to rotate at high cutting speeds. The usual cutting tool materials should reduce abrasion and increase the service life. This succeeds with the help of a cutting tool that is either driven by the workpiece itself or externally and that has a cup point as a cutting edge. This results in a cutting process, by which a fresh cutting edge is continuously introduced into the cutting zone in addition to the otherwise usual infeeds. The rotating, driven tool provides a wide range of possibilities, some of which lead to low cutting forces, an increased shearing angle, a longer service life and a better finish. However, this text also does not refer to creating swarf.

For this reason, a tool needs to be created that can break off chips when reprofiling wheels on wheelsets for railway vehicles in all working ranges. This should also occur for large and small chip cross sections. The tool should have a simple design and be reliable.

According to the patent, a tool is proposed for rotating the wheel tire profile of a railway vehicle wheelset on a wheelset lathe, on which a tool holder is aligned below an acute angle (α) of the tangent to the circle of a cut and is perpendicular to the wheel tire profile and should be able to turn about and move along its longitudinal axis. This tool induces swarf breaking even at low cutting depths.

As is known, the cutting tools used should be cylindrical or mushroom-shaped cutting tools made from a hard material such as carbide or cutting ceramics. The rotation of these types of round cutting tools used for difficult machining when removing chips from wheelsets allows chips to be broken off in areas where this normally would not occur. This is especially the case when the cutting depths are low.

The cutting tool's rotation should be controlled by a motor, have an adjustable speed, and be able to change direction. The cutting tool's rotation additionally deforms the chip passing over it. Depending on the selected rotational direction and speed, the chip can be directed toward a fixed obstacle. The obstacle can be the cuffing tool with a special design or the workpiece, such as the wheelset flank. The rotational motion does not have to be uniform. A brief rotational movement may induce swarf breaking after a certain time, e.g. 100 ms, after the chip has reached a certain length, e.g. 100 mm-wound up).

The CNC control for the wheelset lathe rotates the cutting tool. The cutting tool's rotational direction and speed must be adjustable according to the processing conditions. The cutting tool's rotational direction can be stopped according to the cutting pressure when the cutting depths are large and the infeeds are high. The drive's mechanical design benefits from this since it only needs to produce low torques.

The tool will be used for machining wheelsets with a wheel diameter between 850 mm and 1250 mm for main-line railway vehicles, and approximately 600 mm for tramway vehicles. The rotating tool's bearing is directly mounted and limited to a very small amount of space when machining large workpieces such as wheelsets for main-line railway vehicles. The amount of space available can be increased by aligning the tool with a negative approach angle. For wheelsets, it is recommended to have the tool's rotational axis tilt more toward the wheelset's rotational axis to avoid colliding with the wheel flange. The tool can already have such a tilt. For example, it is possible to combine a stable cutting edge with a tool mount that is closer to the tool and stiff enough. The tool's rotational axis must tilt more toward the wheelset's rotational axis when working with wheelsets. When programming the tool's movements for generating the wheel tire profile be sure that the tool's contact point with the workpiece is changed in relation to a common tool.

Furthermore, when using rotating cutting tools, be sure that the runout in its mount and the form error do not create an undulated surface. For this reason, it is necessary to design and shape the cutting tool's mount within low production tolerances.

Keep in mind that the tool must absorb great strengths within a small amount of space and heats up during operation. Therefore, the tool should be designed in such a way that it remains without play and can still turn perfectly even though it heats up. The following describes the tool with several design examples.

### DRAWINGS

A simplified depiction that is mostly schematic can be seen in the following figures.

FIG. 1A first model of the cutting tool.

FIG. 2 A second model of the cutting tool.

FIG. 3 Cross-section of the drive of a tool.

FIG. 4 The cut through a wheel tire profile (actual size)

### DETAILED DESCRIPTION

The wheel tire profile 1 in FIG. 4 consists of a running surface part 2 and a wheel flange part 3. The radial measuring level 4, is a cut made almost in the middle of the running surface 2 and running perpendicular through the wheel tire profile. FIG. 4 shows the wheelset lathe's machining directions x, y, and z. The y direction runs perpendicular to the plane of projection of FIG. 4.

A wheel 5 of a wheelset (not shown) is placed in a wheelset lathe (not shown) so that is can move about the wheelset's longitudinal axis z in direction 6. FIG. 1 shows a cut through wheel 5 at radial measuring level 4 in FIG. 4. A tool 7 machines the wheel tire profile during rotation. The tool 7 consists of a tool holder 8 and a mushroom-shaped cutting tool 9 made from carbide. The tool holder 8 and the cutting tool 9 are tightly fixed to one another and additionally have protrusions and depressions 10 where they are interlinked. The tool 7 is rotatably mounted in a lathe's tool support (not shown) in the direction of the double arrow 11. The rotational axis 12 is aligned below an acute angle α of the tangent 13 to the radial measuring level 4 of the wheel 5.

The mushroom-shaped cutting tool 9 is designed so that it has flanks 14 that are slanted outward and a depression 15 in the middle.

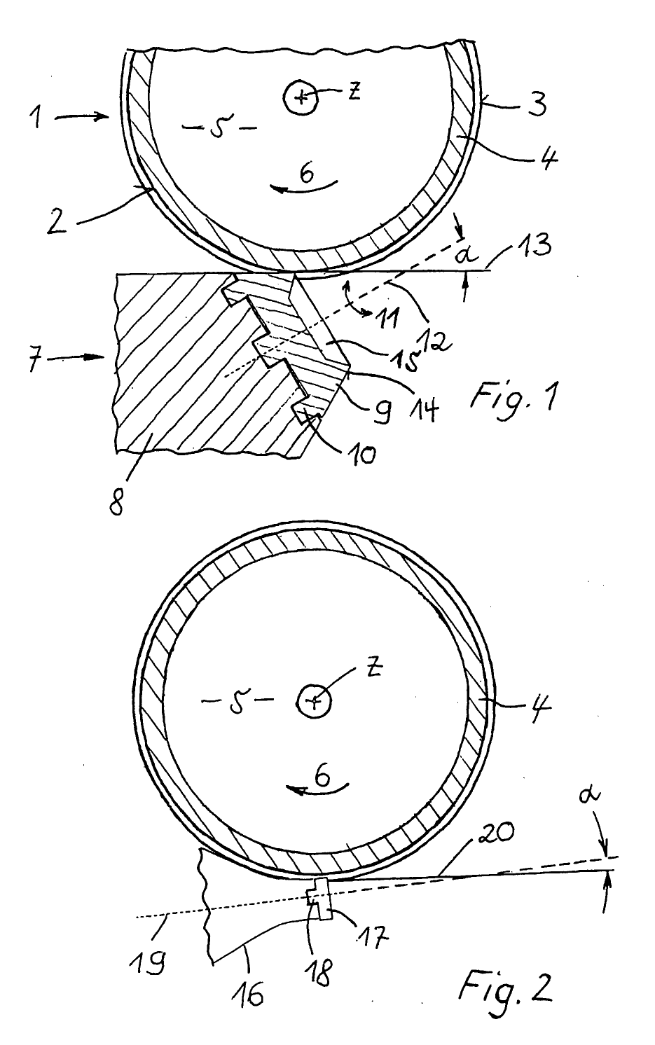

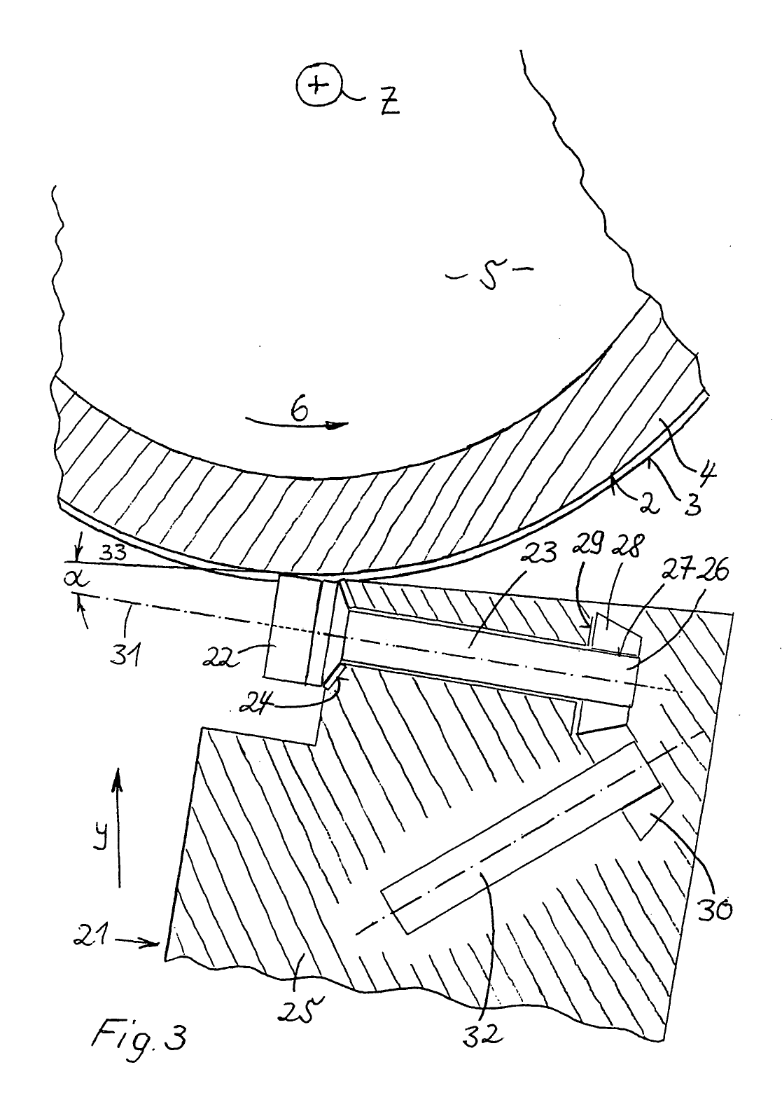

FIG. 2 presents a situation similar to FIG. 1. Here, a tool holder carries a cylindrical cutting tool 17. The tool holder 16 and the cylindrical cutting tool 17 are interlinked at the serration 18. The tool holder 16 with the cylindrical cutting tool 17 is rotatably mounted about its rotational axis 19 in the support (not shown) of a wheelset lathe. The acute angle α between the rotational axis 19 and the wheel tangent 20 is considerably smaller in FIG. 2 than in FIG. 1. This alignment requires the tool holder 16 to have a bottleneck shape in order to be brought as close as possible to the wheel 5.

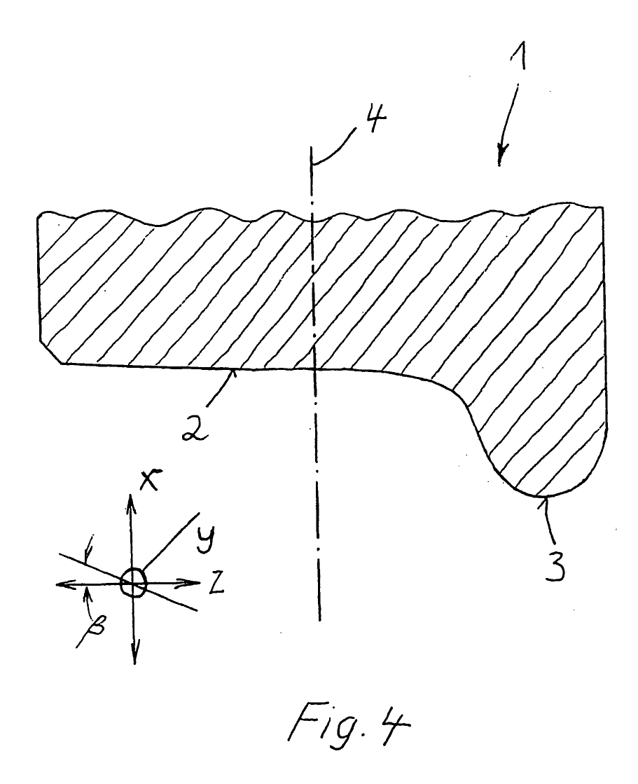

In FIG. 3, a tool 21 must have a cylindrical cutting tool. The cutting tool 22 is soldered to a tool holder 23 that is made of high-strength steel. The tool holder 23 is finished only after the cutting tool 22 has been soldered due to the smooth running of the cutting tool. The tool holder 23 is supported in a slightly conical bearing shell. It is supposed to transfer the cutting forces coming from the main cut for machining and the infeed and passive forces to the base retainer 25 without the cylindrical part of the tool holder 23 being stressed to much. The bearing shell 24 is subject to wear and is replaced along with the cylindrical cutting tool 22. The tool holder 23 has a multi-bevel serration 27 at the bottom 26 that catches with a hardened bevel wheel 28. At point 29, the bevel wheel 28 is supported in antifriction bearings independent of the tool holder 23. The torque that builds up at the rotational axis 31 because of the rotating cylindrical cutting tool 22 is transferred by a second bevel wheel 30 via a high transmission ratio planetary gear train (not shown) to an adjustable servomotor (not shown). Pin 32 is interposed between them. It carries the second bevel wheel 30 that meshes with bevel wheel 28.

The base retainer 25 is pivotally mounted in the wheelset lathe in the x, y, and z direction. The rotational axis 31 of the cylindrical cutting tool 22 is tilted toward the wheel tangent 33 below the angle α.

1-6. (canceled)

7. A device comprising:
a tool including a round cutting edge made of hard material such as carbide or cutting ceramics;
a tool holder for fixing with the cutting tool;
a tool support movable in the x- and z-axes of a lathe, said tool holder being mounted to said tool support such that said tool holder can be rotated and moved along its longitudinal axis and said tool holder is aligned under an acute angle (α) to the tangent of a circle of a cut perpendicular to a workpiece profile;
said tool being provided to turn a wheel tire profile of the wheels of a railway vehicle wheelset on a wheelset lathe at different cutting depths during a single reprofiling cut.

8. The device according to claim 7, wherein said cut is in the measuring circle level of the wheel tire profile of the wheel.

9. The device according to claim 7, wherein the rotational direction of the cutting tool is reversible.

10. The device according to claim 7, wherein the rotational speed of the toolholder is adjustable between 0, which is stand-still, and n, which is a deliberate number of revolutions per minute.

11. The device according to claim 7, wherein the tool holder is aligned under and angle (β) of the rotational axis (z axis) of the wheelset.

12. The device according to claim 11, wherein the acute angle (α) is between 5° and 10° and the angle (β) is between 5° and 10°.
